(19) United States
(12) Patent Application Publication
(10) Pub. No.: US 2018/0083955 A1
(43) Pub. Date: Mar. 22, 2018

(54) MULTI-SESSION AUTHENTICATION

(71) Applicant: eBay Inc., San Jose, CA (US)

(72) Inventors: Vikram Tuli, San Jose, CA (US); Sanjeev Jain, San Jose, CA (US); Gurneet Jandir, San Jose, CA (US); Daniel Morales, San Jose, CA (US)

(21) Appl. No.: 15/269,512

(22) Filed: Sep. 19, 2016

(51) Int. Cl. H04L 29/06; G06F 21/32; H04L 9/32

(52) U.S. Cl. CPC H04L 63/0838; G06F 21/32; H04L 65/1069; H04L 9/3228; H04L 63/0442; H04L 63/0861

(57) ABSTRACT

An approach for multi-session authentication of multiple networked devices is disclosed. A user can create a public key-encrypted message on a client device using biometric data and a one-time password (e.g., one-time password). A door control box can transmit the public key-encrypted message to an authentication server. The authentication server can validate the user by decrypting the encrypted message using the private key, and using the one-time password to recover the valid user identifier (ID). The authentication server can then initiate and maintain multiple networked devices using one or more application programming interfaces (APIs).

### TECHNICAL FIELD

Embodiments of the present disclosure relate generally to user authentication and, more particularly, but not by way of limitation, to configuring one or more network sessions using multi-session authentication.

### BACKGROUND

in recent years, physical access systems that control entrances (e.g., doors, windows) have been hacked and malicious users have gained unauthorized access to secure areas. Once in the secure area, the malicious users can further compromise computers, phone systems, and data stores to steal data and cause network harm. It is to these issues that the below approaches are directed.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a multi-session authentication system implemented in a networked system, according to some example embodiments.

FIG. 2A is a block diagram showing example components provided within a client application of FIG. 1, according to some example embodiments.

FIG. 2B is a block diagram showing example components provided within the multi-session authentication system of FIG. 1, according to some example embodiments.

FIG. 3 illustrates a high-level method for implementing multi-session authentication of network devices, according to some example embodiments.

FIG. 4 illustrates an example network architecture for implementing multi-session authentication involving a client device, a building, and a multi-session authentication system communicating over a network, according to some example embodiments.

FIGS. 5A-C illustrate a flow diagram of a method for implementing multi-session authentication, according to some example embodiments.

FIG. 6 illustrates a flow diagram of a method for terminating one or more network sessions, according to some example embodiments.

FIG. 7 illustrates a flow diagram of a method for terminating one or more network sessions upon occurrence of an event, according to some example embodiments.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, multi-session authentication is implemented using communications between a client device, a building control system, and an authentication server hosting a multi-session authentication system. On the client device, a user unlocks the client device using a biometric sensor (e.g., fingerprint scanner). The user may initiate a client application on the client device which further requests a biometric verification over the biometric sensor of the client device. The client application identifies a user ID for the user. The user ID is used as a seed to generate a one-time password (OTP), which functions as a password that can only be used for authentication purposes once (e.g., for a single session). One-time passwords provide increased security by making it difficult for attackers (e.g., malicious users) to discover or predict the users password. Although one-time passwords increase security, changing passwords multiple times is difficult and impractical for human users to complete without use of a computer. By implementing the one-time passwords via the password engine, discussed in further detail below, a user can more easily be provided with strong network security.

Continuing, the one-time password is then encrypted using a public key of an asymmetric key pair assigned to the user. The encrypted message can be transmitted to a door-mounted sensor over Bluetooth. The door-mounted Bluetooth sensor then transmits the encrypted message to a control box for further processing. In some example embodiments, the control box is a pre-installed control box configured to drive electronic locks to unlock multiple doors of a company's building. Unfortunately, control boxes are susceptible to hacking and it has been demonstrated that malicious users can hack control boxes to gain unauthorized access to secure areas (e.g., a company's headquarters).

To increase security of the control box access approach, the control box is configured to send door authorization requests to a multi-session authentication system hosted on an authentication server. In particular, the native network address in the control box can be replaced with the network address of the authentication server hosting the multi-session authentication system. As such, when the control box receives the encrypted message, instead of verifying the user at the control box or sending the encrypted message to a native server that is not configured to interpret the public key-encrypted message, the control box sends the encrypted message to the updated address of the authentication server hosting the multi-session authentication system.

The multi-session authentication system has access to the other key of the key pair, i.e., the private key. For example, the private key can be stored in non-transitory memory of the authentication server or can be provided to the multi-session authentication system via a key server. The multi-session authentication system then decrypts the encrypted message to expose the one-time password. The one-time password is then used to recover the original user ID for the user. Next, the multi-session authentication system checks to determine whether the user ID matches a known valid user by checking a user ID database. If the user ID generated from the decryption process matches a known user ID, then the user is authenticated. The multi-session authentication system can then initiate one or more network session devices, such as by unlocking the door, initiating a computing environment for the user (e.g., desktop, laptop, virtual machine, zero client, thin client, operating system-level container-based application), initiating an internet protocol (IP) phone, or initiating other network devices that can be initiated for a single session (e.g., one work day). Other features and embodiments are discussed in further detail with reference to the figures.

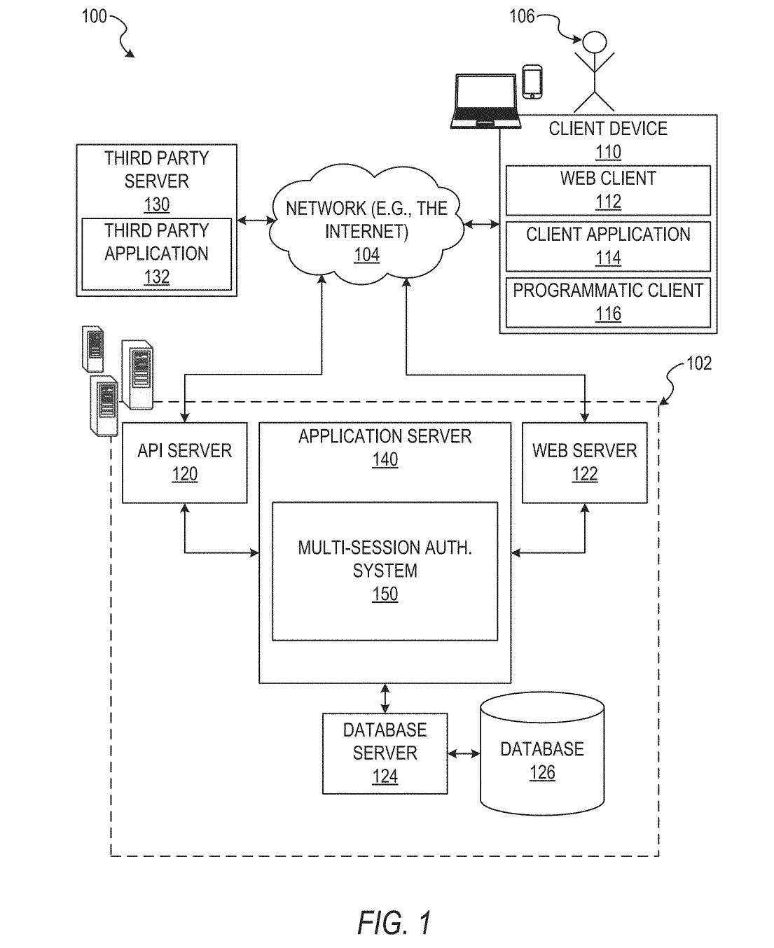

With reference to FIG. 1, an example embodiment of a high-level client-server-based network architecture 100 is shown. A networked system 102 provides server-side functionality via a network 104 (e.g., the Internet or a Wide Area Network (WAN)) to one or more client devices 110. In some implementations, a user 106 interacts with the networked system 102 using the client device 110. FIG. 1 illustrates, for example, a web client 112 (e.g., a browser), a client application 114, and a programmatic client 116 executing on the client device 110. The client device 110 includes the web client 112, the client application 114, and the programmatic client 116 alone, together, or in any suitable combination. Although FIG. 1 shows one client device 110, in other implementations, the network architecture 100 comprises multiple client devices.

In various implementations, the client device 110 comprises a computing device that includes at least a display and communication capabilities that provide access to the networked system 102 via the network 104. The client device 110 comprises, but is not limited to, a remote device, work station, computer, general-purpose computer, Internet appliance, hand-held device, wireless device, portable device, wearable computer, cellular or mobile phone, Personal Digital Assistant (PDA), smart phone, tablet, ultrabook, netbook, laptop, desktop, multi-processor system, microprocessor-based or programmable consumer electronic system, game console, set-top box, network Personal Computer (PC), mini-computer, and so forth. In an example embodiment, the client device 110 comprises one or more of a touch screen, accelerometer, gyroscope, biometric sensor, camera, microphone, Global Positioning System (GPS) device, and the like.

The client device 110 communicates with the network 104 via a wired or wireless connection. For example, one or more portions of the network 104 comprise an ad hoc network, an intranet, an extranet, a Virtual Private Network (VPN), a Local Area Network (LAN), a wireless LAN (WLAN), a WAN, a wireless WAN (WWAN), a Metropolitan Area Network (MAN), a portion of the Internet, a portion of the Public Switched Telephone Network (PSTN), a cellular telephone network, a wireless network, a Wireless Fidelity (WI-FI®) network, a Worldwide Interoperability for Microwave Access (WiMax) network, another type of network, or any suitable combination thereof.

In some example embodiments, the client device 110 includes one or more applications (also referred to as “apps”) such as, but not limited to, web browsers, book reader apps (operable to read e-books), media apps (operable to present various media forms including audio and video), fitness apps, biometric monitoring apps, messaging apps, and electronic mail (email) apps. In some implementations, the client application 114 include various components operable to present information to the user 106 and communicate with the networked system 102.

The web client 112 accesses the various systems of the networked system 102 via the web interface supported by a web server 122. Similarly, the programmatic client 116 and client application 114 access the various services and functions provided by the networked system 102 via the programmatic interface provided by an Application Program Interface (API) server 120.

The user 106 comprises a person, a machine, or another means of interacting with the client device 110. In some example embodiments, the user 106 is not part of the network architecture 100, but interacts with the network architecture 100 via the client device 110 or another means. For instance, the user 106 provides input (e.g., touch screen input or alphanumeric input) to the client device 110 and the input is communicated to the networked system 102 via the network 104. In this instance, the networked system 102, in response to receiving the input from the user 106, communicates information to the client device 110 via the network 104 to be presented to the user 106. In this way, the user 106 can interact with the networked system 102 using the client device 110.

The API server 120 and the web server 122 are coupled to, and provide programmatic and web interfaces respectively to, one or more application servers 140. The application server 140 can host a multi-session authentication system 150, which can comprise one or more modules or applications, and which can be embodied as hardware, software, firmware, or any combination thereof. The application server 140 is, in turn, shown to be coupled to a database server 124 that facilitates access to one or more information storage repositories, such as a database 126. In an example embodiment, the database 126 comprises one or more storage devices that store information to be accessed by the multi-session authentication system 150 or the client device 110. Additionally, a third-party application 132, executing on a third-party server 130, is shown as having programmatic access to the networked system 102 via the programmatic interface provided by the API server 120. For example, the third-party application 132, utilizing information retrieved from the networked system 102, supports one or more features or functions on a website hosted by a third party.

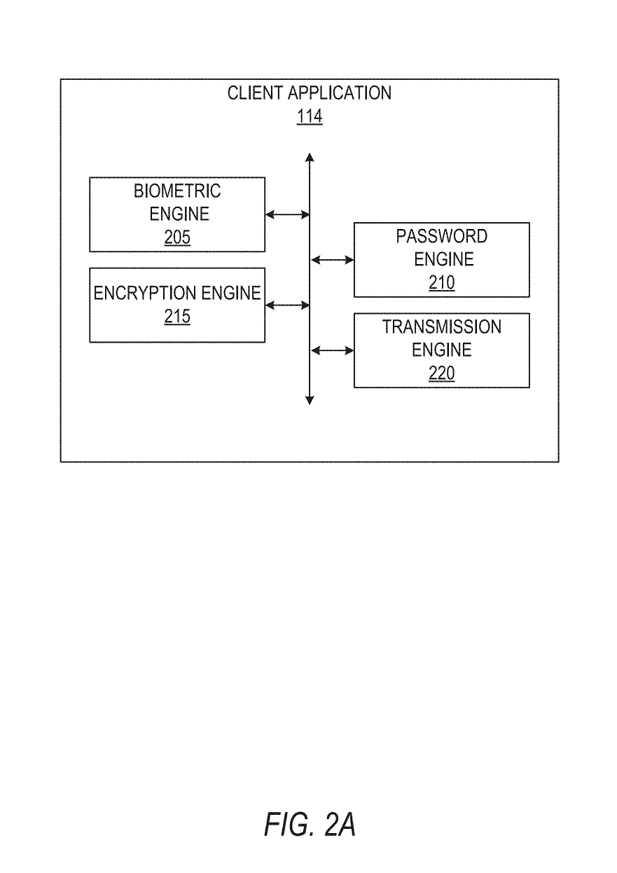

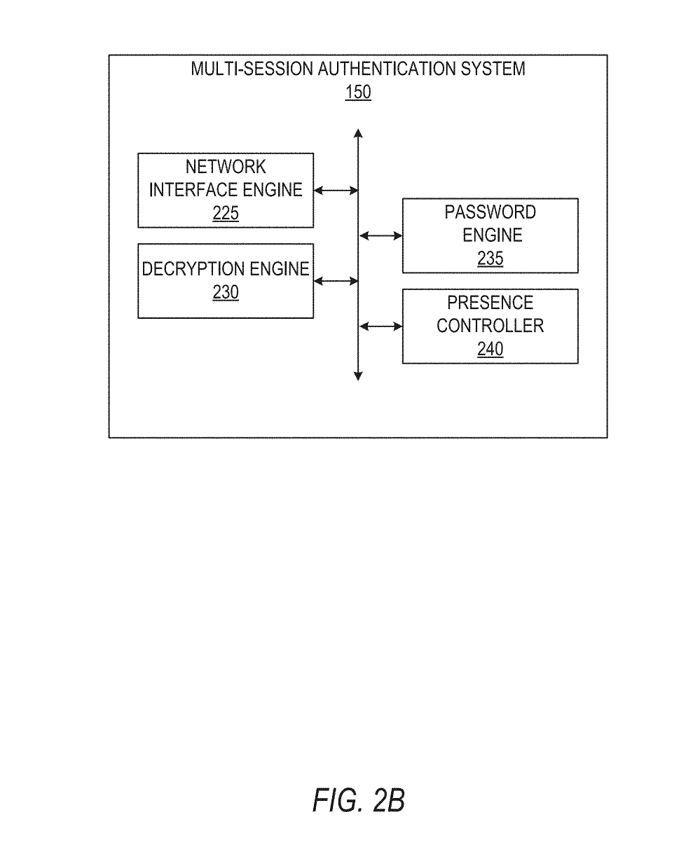

In some implementations, the multi-session authentication system 150 provides functionality to securely authenticate the user 106 and initiate sessions for one or more network session devices. The multi-session authentication system 150 will be discussed further in connection with FIG. 2B below.

Further, while the client-server-based network architecture 100 shown in FIG. 1 employs a client-server architecture, the present inventive subject matter is, of course, not limited to such an architecture, and can equally well find application in a distributed, or peer-to-peer, architecture system, for example. The various systems of the application server 140 (e.g., the multi-session authentication system 150) can also be implemented as standalone software programs, which do not necessarily have networking capabilities.

Furthermore, the components access the database 126 via the database server 124.

FIGS. 2A and 2B illustrate client-side and server-side components that are configured to work with one another, according to various example embodiments. In particular, for example, requests generated on the client side (e.g., by the client application 114) are configured to be received by and fulfilled by a server (e.g., the multi-session authentication system 150) on the server side. Although the client side and the server side are discussed here as examples, it will be appreciated that in some example embodiments, the functionalities of the client side and the server side can be integrated and performed by a single integrated machine (e.g., door-mounted control unit).

FIG. 2A illustrates internal components of the client application 114 executed on the client device 110, according to some example embodiments. The components themselves are communicatively coupled (e.g., via appropriate interfaces) to each other and to various data sources, so as to allow information to be passed among the components or so as to allow the components to share and access common data. Though the internal components are illustrated as executing on the client application 114, it will be appreciated that the same components can be integrated to execute within a browser environment (e.g., execute within the web client 112 as a browser-based cloud application). In FIG. 2A, the client application 114 comprises a biometric engine 205, a client-side password engine 210, an encryption engine 215, and a transmission engine 220. The biometric engine 205 is configured to receive biometric data from the user and authenticate the user based on matching the biometric data to valid biometric data for the user. The client-side password engine 210 is configured to generate a one-time password from a seed. In some example embodiments, the seed is a user identifier (ID) for the user. The user ID can be used to preconfigure various network sessions and environments (e.g., virtual machine desktop, Internet Protocol (IP) phone, physical entrance systems) for the user. The encryption engine 215 is configured to generate an encrypted message by encrypting the one-time password using a public key of a key pair assigned to the user. The transmission engine 220 is responsible for transmitting the encrypted message to a sensor interface of an access point. In some embodiments, the encrypted message can be conveyed from the client device 110 to the sensor interface via Bluetooth. In the example embodiment implementing Bluetooth, the transmission engine 220 is a Bluetooth module (e.g., Bluetooth chip comprising a receiver and management logic), and the sensor interface of the access point is a Bluetooth receiver. In other example embodiments, the transmission engine 220 can interface with the sensor interface of the access point through other wireless connections, such as WI-FT® or Radio Frequency Identification (RFID) tag protocol, or through wired connections, such as a Universal Serial Bus (USB) connection.

FIG. 2B illustrates internal components of the multi-session authentication system 150, according to some example embodiments. The components themselves are communicatively coupled (e.g., via appropriate interfaces) to each other and to various data sources, so as to allow information to be passed among the components or so as to allow the components to share and access common data. As illustrated, the multi-session authentication system 150 comprises a network interface engine 225, an decryption engine 230, a server-side password engine 235, and a presence controller 240. The network interface engine 225 is a public network-facing (e.g., Internet-facing) interface having a network address (e.g., IP address) to which a control box directs the encrypted message for authentication. The decryption engine 230 is configured to authenticate the user by attempting to decrypt the encrypted message with the private key of the key pair assigned to the user. In some example embodiments, the public key is stored on the client device 110 for use by the encryption engine 215, and the private key is stored on the multi-session authentication system 150. In some example embodiments, a key server (not depicted) is implemented on the server side (e.g., within the networked system 102) to manage the key pair processes for the multi-session authentication system 150. If the decryption engine 230 successfully decrypts the encrypted message to expose the one-time password, the user is authenticated. The server-side password engine 235 is configured to use the exposed one-time password to generate the user ID. The presence controller 240 is configured to identify the user ID and initiate one or more network session environments for the user through one or more APIs. For example, the presence controller 240 can send an unlock signal to a control box that (hives current to an electronic door lock, causing the door lock to unlock and enabling the user to enter a building through the door. Further, the presence controller 240 can initiate additional network session environments, such as a computing environment on a desktop or laptop computer for the user 106, internal network access for the computing environment, an IP phone for the user 106, air conditioning, lighting, motion security access, and other additional sessions, each configurable through an API.

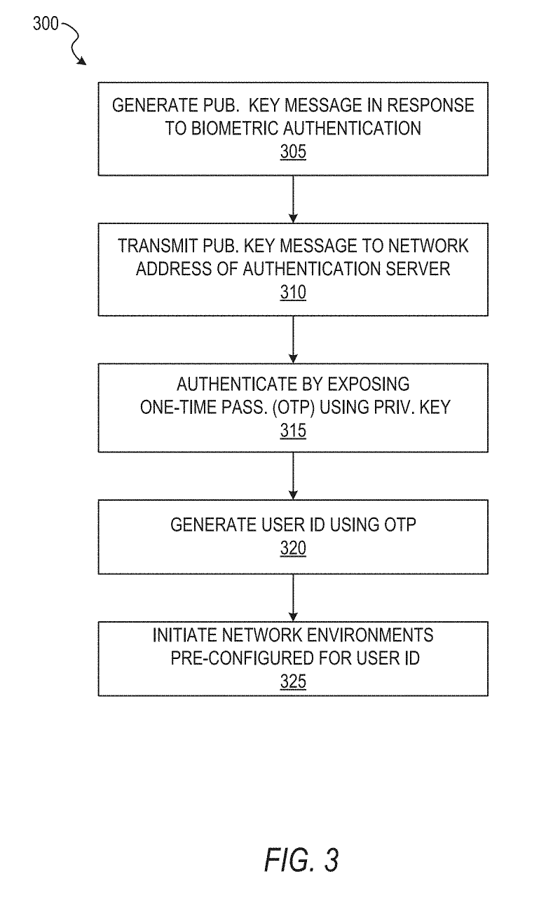

FIG. 3 illustrates a flow diagram for a method 300 for implementing multi-session authentication, according to some example embodiments. At operation 305, the client device 110 of the user 106 generates a public key-encrypted message in response to the user 106 being biometrically authenticated on the client device 110. The public key-encrypted message is a message created by encrypting a one-time password created from a user ID for the user. At operation 310, the transmission engine 220 on the client device 110 transmits the encrypted message to the sensor interface of the access point, which relays the encrypted message to a control box for the access point, which relays the encrypted message to a network address of an authentication server. In some example embodiments, a native network address of an authentication server is stored within the control box upon the control box being shipped or released by the manufacturer for sale. To implement the multi-session authentication approaches disclosed herein, the native network address of the control box is updated by replacing the native network address with the network address of the multi-session authentication system 150.

In some example embodiments, the operations of 305 and 310 are performed automatically by the multi-session authentication system 150 without user interaction. For example, the biometric sensor can be implemented as a wall-mounted retinal scanning camera that identifies users via eye-scan as the users approach a building's entrance (e.g., physical access point, gate, door). Once the multi-session authentication system 150 receives the biometric data, the other operations e.g., one-time password creation, encryption, transmission of the message to a door sensor) can be automatically completed by the multi-session authentication system 150 so that the user's are granted access to the building (e.g., doors unlocked) without waiting for user interaction.

At operation 315, the decryption engine 230 authenticates the user 106 by successfully decrypting the encrypted message using the private key of the key pair assigned to the user. At operation 320, the server-side password engine 235 uses the one-time password to generate the user ID. At operation 325, the presence controller 240 uses the user ID to set up one or more network sessions for the user, such as a computing environment, an IP phone, or access to one or more doors.

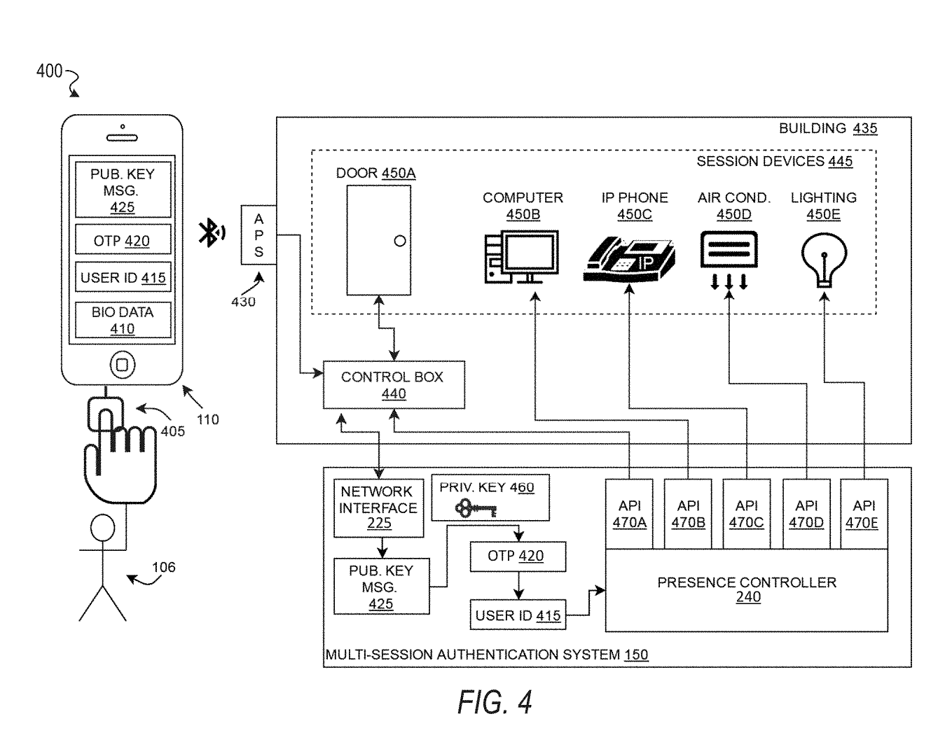

FIG. 4 illustrates an example network architecture 400 for implementing multi-session authentication, according to some example embodiments. In FIG. 4, the user 106 is attempting to gain access to a building 435 by using his/her client device 110 to check in through an access point sensor interface 430 (e.g., a Bluetooth-, RFID-, or WI-FI®-enabled receiver). Some items in FIG. 4 correspond to internal components illustrated in FIGS. 2A and 2B (e.g., the network interface engine 225 and presence controller 240), while some items in FIG. 4 correspond to data items (e.g., private key 460) or physical items (e.g., door 450A). Further, in the example network architecture 400, the client device 110 is physically separate from the building 435, and the authentication server is a remote server (e.g., application server 140) hosting the multi-session authentication system 150. It will be appreciated, however, that in some example embodiments, the functionality of the multi-session authentication system 150 can be integrated into the building 435. For example, the application server 140 may be located physically inside the building 435, a campus including the building 435, or part of a closed network provided to the building 435. In some embodiments, the user 106 is an employee of a company that owns the building 435, and the multi-session authentication system 150 is provided as a paid-for security service through the cloud (e.g., a web service provided through the network 104).

As an illustrative example, as part of his/her morning work routine, assume that the user 106 approaches the door 450A to enter the building 435. Standing outside the building 435, in range of the access point sensor interface 430 (e.g., within Bluetooth range), the user 106 unlocks his/her client device 110 by using a biometric sensor 405. For example, the user 106 presses his/her finger against a fingerprint reader sensor, the client device 110 receives the fingerprint and compares it with the valid fingerprint (e.g., the fingerprint the user 106 stored on the client device 110 during a registration process), and the client device 110 unlocks, exposing one or more app icons to launch client device applications. The user 106 selects an icon that launches the client application 114. The client application 114 is initialized, and displays a graphical user interface (GUI) requesting that the user 106 use the biometric sensor 405 to authenticate him/herself with the client application 114. In some example embodiments, the operating system of the client device 110 provides system calls that allow the client application 114 to use the fingerprint data stored in the operating system. In some example embodiments, the user 106 must further register his/her biometric data 410 (e.g., fingerprint data) with the client application 114. For example, the user 106 stores his/her fingerprint data using the biometric engine 205, which authorizes the user 106 to use the client application 114. Further, in response to successful biometric authentication at the client device 110, the client-side password engine 210 identifies a user ID 415. The user IT) 415 is an identifier (e.g., employee number) that uniquely identifies the user 106 to the multi-session authentication system 150. The user IT) 415 is used by the multi-session authentication system 150 to initiate multiple network session environments for the user 106. For example, each of the network session environments can comprise different tools to be used by the user 106 to perform work for his/her company. A network administrator for the company can use the user ID 415 to authorize the user 106 to use the various environments (e.g., access the building 435, initialize an IP phone) when the user 106 is hired by the company.

In some example embodiments, the client-side password engine 210 uses the user ID 415 to generate a one-time password 420 that operates as a one-time password for a given login session (e.g., one work day). In some example embodiments, the one-time passwords are generated in such a way that each can be tracked back to the corresponding user ID. That is, each user ID is a seed used in a one-time password scheme (e.g., Time-based One-time Password Algorithm (TOTP), HMAC-based One-time Password Algorithm (HTOP)) to generate each new one-time password, which can later be used to recover the seed, e.g., the user ID.

After the one-time password 420 is generated, the encryption engine 215 generates a public key-encrypted message 425 by encrypting the one-time password 420 using a public key of an asymmetric cryptographic key pair assigned to the user 106. The key pair can be assigned to the user 106 during the registration process (e.g., when the employee is hired, and the different network sessions are authorized). In some example embodiments, the public key is stored on the client device 110 for use by the encryption engine 215 to generate the encrypted message. Further, according to some example embodiments, the private key of the key pair is stored on the server side, e.g., in memory accessible to the decryption engine 230.

Next, the transmission engine 220 transmits the public key-encrypted message 425 to the access point sensor interface 430. For example, the transmission engine 220 transmits the public key-encrypted message 425 to the access point sensor interface 430 over Bluetooth. In some example embodiments, the access point is a collective system comprising the access point sensor interface 430, a control box 440, and a building entrance, such as the door 450A. The control box 440 is a logical control module (e.g., physical hardware, firmware, and/or software for implementing a physical access control system) that receives data from the access point sensor interface 430, sends it for validation to a server, and if the control box 440 receives a positive response from the server, drives current to an electronic door lock mounted on the door 450A. In some example embodiments, the control box 440 may be configured to receive authorization signals (e.g., door unlock signals) from the server as a network target over TCP/IP. In some example embodiments, the native network address of the network target is updated with the IP address of the multi-session authentication system 150 such that all future validation requests (e.g., validation messages) are forwarded to the multi-session authentication system 150 over the network 104 (e.g., over TCP/IP).

Continuing the example, the access point sensor interface 430 receives the public key-encrypted message 425 from the client device 110 and transmits it to the control box 440. The control box 440 then transmits the public key-encrypted message 425 to a network address of the multi-session authentication system 150. The network interface engine 225 is configured to interface with different systems over TCP/IP. In particular, the network interface engine 225 receives the public key-encrypted message 425 and transfers it to the decryption engine 230 for further processing. Next, the decryption engine 230 uses the private key 460 to authenticate the user 106 by attempting to decrypted the public key-encrypted message 425. The decryption process exposes the underlying one-time password 420. Next, the server-side password engine 235 uses the one-time password 420 to recover the user ID 415 as discussed above (e.g., using different approaches such as TOTP and HTOP).

In some example embodiments, to ensure that the decryption was successful and the user ID 415 recovery process was successful, the user ID 415 can be checked against known records of all users registered for the system. For example, all of the user IDs, each of which is cryptographically unique, are stored in the database 126. The encryption message data is decrypted using the private key to produce first output data. The decryption engine 230 then uses the one-time password algorithm to generate second output data. At this point, it may be unclear to the multi-session authentication system 150 whether the second output data is valid, as it may be garbled or otherwise mixed-up data generated from a fake encrypted message. To authenticate the second output data as valid, and thus authenticate the user, the decryption engine 230 accesses the database 126 and determines whether the second output data matches any stored user IDs. If the second output data matches a known user ID, the user 106 is authenticated since each of the user IDs is cryptographically unique.

Continuing the example, the user ID 415 is transmitted to the presence controller 240. The presence controller 240 determines which network sessions are authorized for use by the user 106. Assuming that the user 106 is authorized for all available network sessions, the presence controller 240 uses one or more APIs, such as APIs 470A-E, to initiate different session devices 445 for the user 106. Each of the APIs 470A-E is configured to interact with and manage the different network sessions. For example, the control box 440 is configured to receive an authorization signal (e.g., a signal to unlock the door 450A) in a certain format specified by the manufacturer of the control box 440. As such, the API 470A is configured to generate the correct authorization signal per the format specifications. The control box 440 receives the authorization signal and drives current to the door lock, thereby unlocking the door 450A and allowing the user 106 to enter the building 435.

As the user 106 walks towards his/her workspace (e.g., cubicle), the presence controller 240 further initiates additional network sessions for the user 106. For example, the presence controller 240 may set up a computer 450B having network connectivity via the API 470B; further, the presence controller 240 may initiate an IP phone 450C via the API 470C, an air conditioning unit 450D via the API 470D, and workspace lighting 450E for the user 106 via API 470E. Additional network session devices can likewise be configured. In some example embodiments, by the time the user 106 approaches or sits down at his/her workspace, all of the authorized network session devices are initiated and ready for use; e.g., the computer 450B is ready to launch programs (e.g., email already logged in), and the IP phone 450C has a dial tone and is ready to make calls.

In some example embodiments, the presence controller 240 maintains a table with entries that track what network session devices each user can use. For example, an entry in the table may specify that a first user may be authorized to access the building 435 but not be authorized to access computers in the building 435. Thus, the presence controller 240 would unlock the door 450A for the first user but not initiate any other network session devices. A second user may be authorized to access some doors but not others, and may be authorized to use a phone. Consequently, the presence controller 240 unlocks the permitted doors (e.g., authorizes the doors to unlock in response to reading a user badge or signal from the client device 110), and also authorizes a phone for the second user.

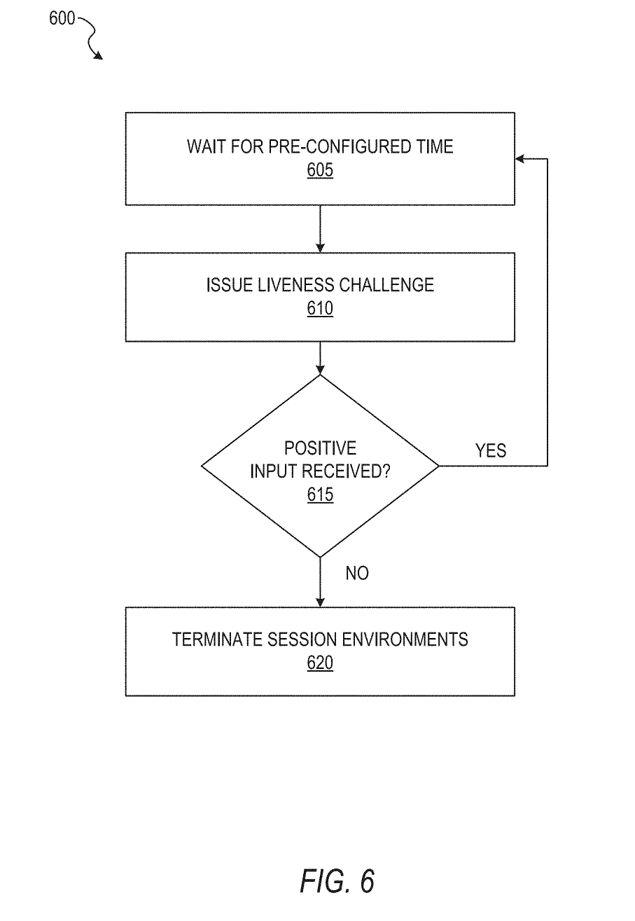

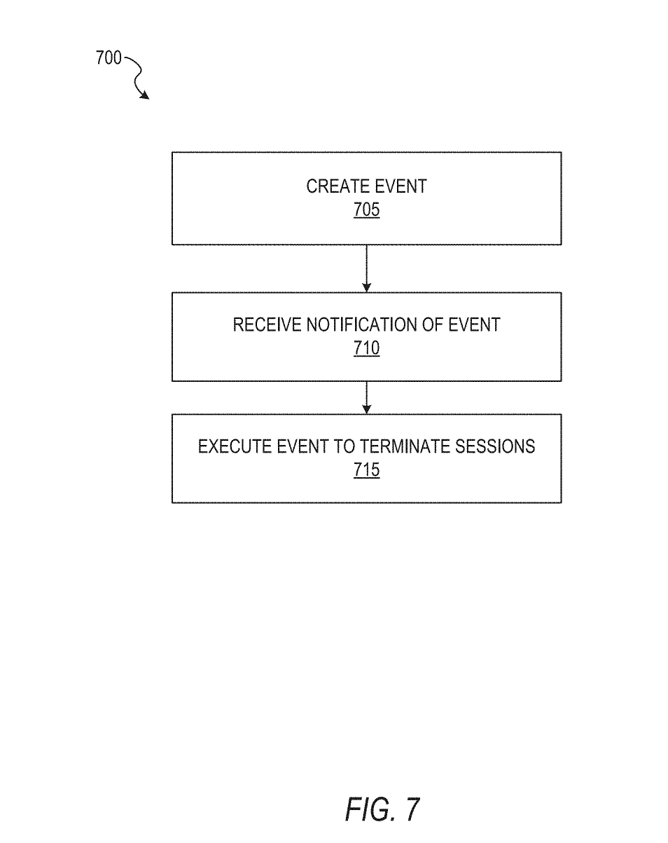

Termination of network session devices is also managed by the presence controller 240, according to some example embodiments. For example, at the end of the workday (e.g., 6 PM) the presence controller 240 terminates the network connectivity and shuts down the computer 450B, terminates the IP phone 450C, and allows the user 106 to exit but not enter through doors, such as the door 450A. Further details of network session device termination are discussed with reference to FIGS. 6 and 7.

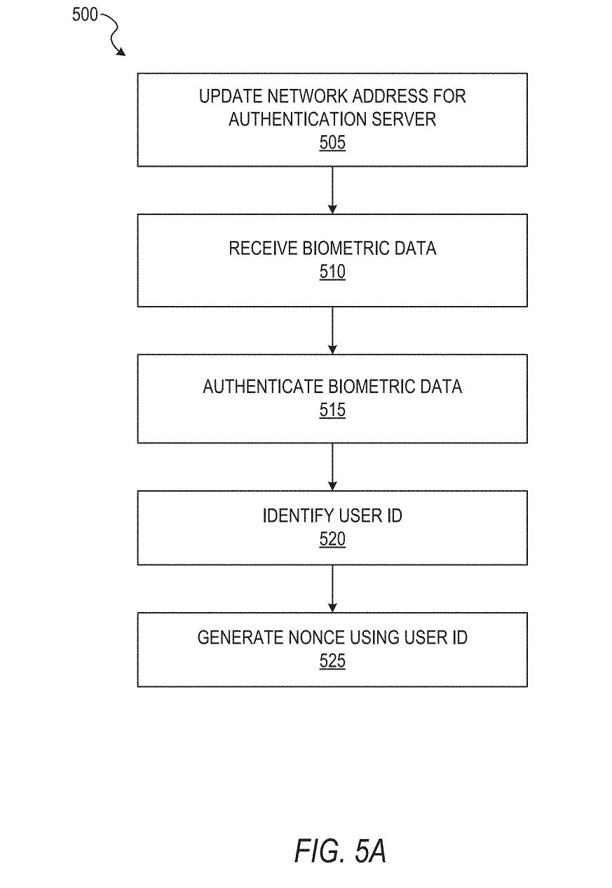

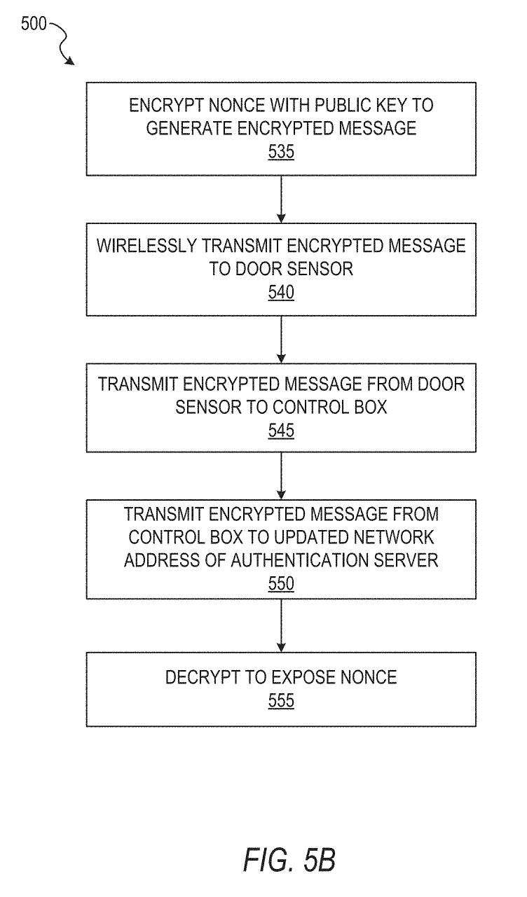

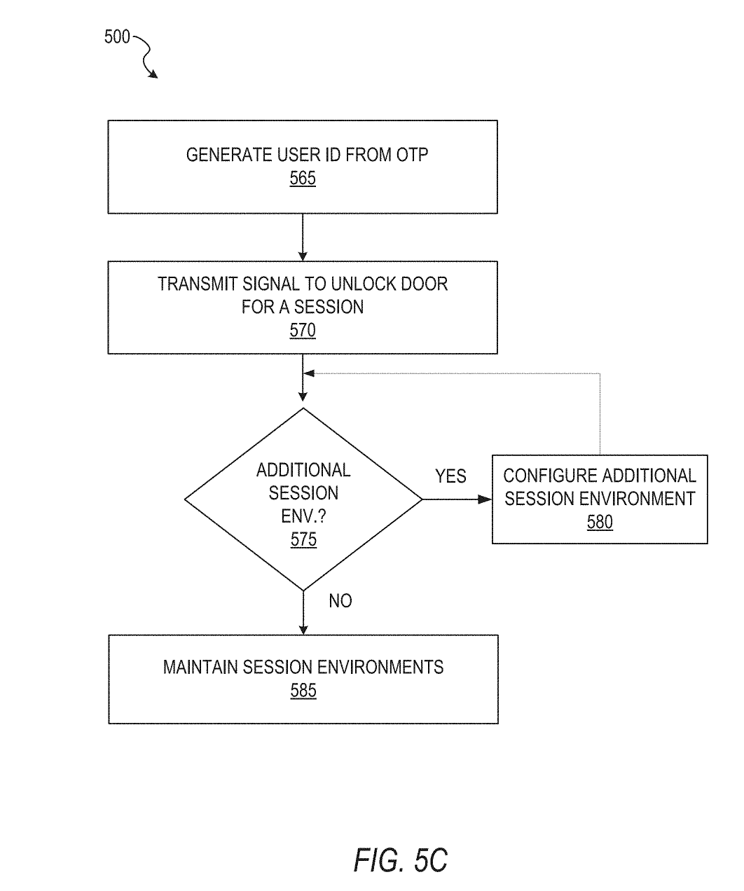

FIGS. 5A-C illustrate flow diagrams of a method 500 for implementing multi-session authentication, according to some embodiments. With reference to FIG. 5A, at operation 505, the target network address of the control box is updated from the native network address to the network address of the authentication server (e.g., application server 140, which hosts the multi-session authentication system 150). At operation 510, on the client device 110, the biometric engine 205 receives biometric data from the user though a biometric sensor (e.g., skin pattern recognition devices, retina scanning devices, facial recognition devices) coupled to the client device 110.

At operation 515, the biometric engine 205 authenticates the user by matching the received biometric data to known valid biometric data previously registered with the client device 110 by the user. At operation 520, the client-side password engine 210 identifies the user ID assigned to the user. At operation 525, the client-side password engine 210 uses the user ID as a seed to generate a one-time password (e.g., one-time password).

With reference to FIG. 5B, at operation 535, the encryption engine 215 generates an encrypted message by encrypting the one-time password using the public key assigned to the user. At operation 540, the transmission engine 220 wirelessly transmits the encrypted message to a sensor interface, such as a door-mounted Bluetooth sensor pad (“door sensor”). In some example embodiments, the biometric data is used to validate the user at the client device 110 and unlock access to the user ID. According to some example embodiments, the biometric data is not transmitted in the encrypted message but rather always stays on the client device 110 to maintain higher security and avoid biometric data theft.

At operation 545, the sensor interface transmits the encrypted message to the control box for further processing. As discussed, in some example embodiments, the control box is mounted in the building and is not easily removable or modifiable. However, to provide increased security, the target network address can be updated to redirect validation messages from the native network address to the network address of the multi-session authentication system 150. Accordingly, at operation 550, the control box transmits the encrypted message to the updated network address of the authentication server, i.e., the address of the multi-session authentication system 150. At operation 555, the decryption engine 230 decrypts the encrypted message to expose the one-time password.

With reference to FIG. 5C, at operation 565, the server-side password engine 235 generates or otherwise identifies the user ID using the one-time password. At operation 570, the presence controller 240 checks the authorization table to determine whether the user has door access, and if so, transmits a signal to the control box, thereby causing the control box to drive current to the electronic lock and unlock the door for the user. In some example embodiments, a gate, checkpoint gate (e.g., library entrance sensors), or other type of physical access point can be authorized to let the user enter. At operation 575, the presence controller 240 then checks the authorization table to determine whether there are additional network session devices to configure for the user. If there are additional network session devices to configure, then the method 500 goes to operation 580 where the next network session device is configured for the user. The method 500 may then loop over operations 575 and 580 until all network session devices are configured for the user. At operation 575, if there are no additional network session devices to configure, then the method 500 proceeds to operation 585 where the presence controller 240 maintains the one or more network sessions for the user. For example, the user may request access to different doors, and each door can be checked against the authorization table to determine whether the user should be granted entrance at the various doors.

FIG. 6 illustrates a flow diagram of a method 600 for terminating the one or more sessions being maintained for the user via liveness challenges, according to some embodiments. At operation 605, the presence controller 240 waits for a pre-configured time such as 30 minutes of user inactivity. For example, if the user has not pressed a key or used the mouse of the computer 450B for 30 minutes, the presence controller 240 would consider that the pre-configured time had elapsed. At operation 610, the presence controller 240 issues a liveness challenge to the user. For example, at operation 610 the presence controller 240 causes a user interface to pop up that asks the user, “Are you still using this console?” and further displays “Yes” and “No” buttons. At operation 615, if the user selects the “Yes” button, then the method 600 proceeds to operation 605 to wait for the next pre-configured time of user inactivity. In contrast, if the user selects the “No” button, or does not respond within a specified time period (e.g., 10 seconds), then the presence controller 240 at operation 620 terminates one or more sessions created for the networked session devices. In some example embodiments, the liveness challenge is performed with a user display as discussed above, while in some example embodiments, the liveness challenge requests an auditory positive response from the user (e.g., the user speaks the words “Yes, I am still here”). In some example embodiments where the building is configured with motion detectors, the user can wave his/her arms to provide positive user input to extend the user sessions.

FIG. 7 illustrates a flow diagram of a method 700 for terminating the one or more sessions being maintained for the user upon occurrence of a specified event, such as a time of day, according to some embodiments. At operation 705, the presence controller 240 creates an event function that waits for the occurrence of a specified event. For example, at operation 705, the presence controller 240 creates a timer event function that waits for a specified time, e.g., 5:00 PM PST. At operation 710, the presence controller 240 receives notification of the event occurring (e.g., the system time of the application server 140 is 5:00 PM PST). Upon notification of the event occurring, an event handler function is executed by the presence controller 240 at operation 715. Upon execution, the event handler function is configured to terminate specified network sessions, e.g., terminating the network connectivity of the computer 450B, or allowing the user to exit the door 450A but not enter it.

Certain embodiments are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some embodiments, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules can be located in a single geographic location (e.g., within a home environment, an office environment, or a server farm). In other example embodiments, the processors or processor-implemented modules are distributed across a number of geographic locations.

The modules, methods, applications and so forth described in conjunction with FIGS. 1-7 are implemented in some embodiments in the context of a machine and an associated software architecture. The sections below describe a representative software architecture and machine (e.g., hardware) architecture that are suitable for use with the disclosed embodiments.

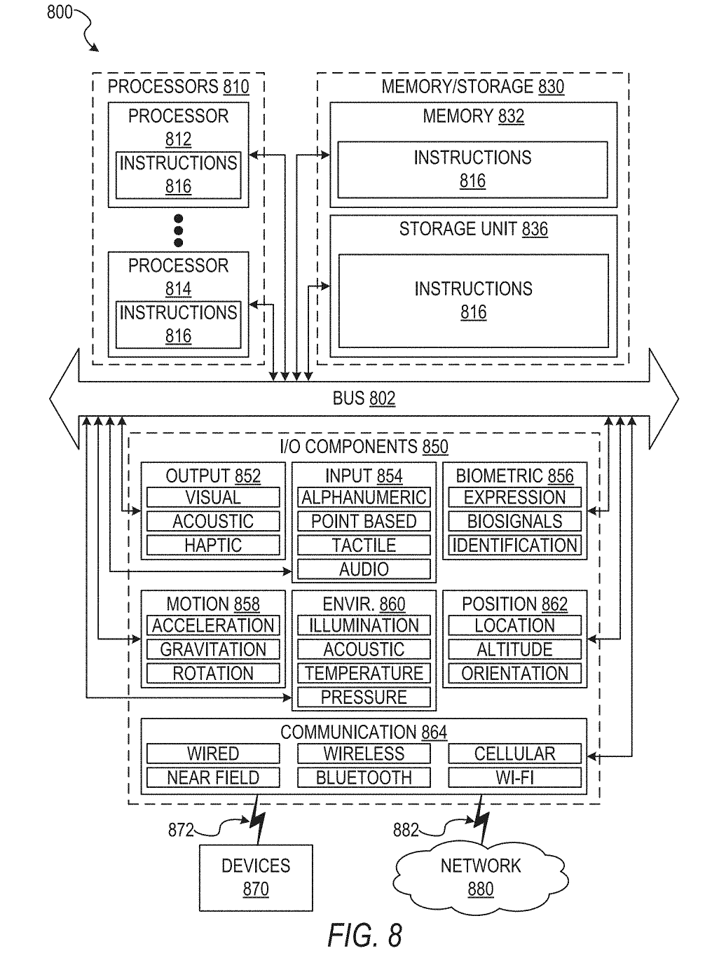

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 (e.g., client device 110, application server 140) in the example form of a computer system, within which instructions 816 (e.g., software, a program, an application, an applet, an app, or other executable code) for causing the machine 800 to perform any one or more of the methodologies discussed herein can be executed. For example, the instructions 816 can cause the machine 800 to execute the flow diagrams of FIGS. 3, 5A-C, 6, and 7. Additionally, or alternatively, the instructions 816 can implement the biometric engine 205, the client-side password engine 210, the encryption engine 215, and the transmission engine 220 of FIG. 2A. Additionally, or alternatively, the instructions 816 can implement the network interface engine 225, the decryption engine 230, the server-side password engine 235, and the presence controller 240 of FIG. 2B. The instructions 816 transform the general, non-programmed machine into a particular machine programmed to carry out the described and illustrated functions in the manner described. In alternative embodiments, the machine 800 operates as a standalone device or can be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 can comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 can include processors 810, memory/storage 830, and I/O components 850, which can be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (CPU), a Digital Signal Processor (DSP), an ASIC, a Radio-Frequency Integrated Circuit (RFIC), another processor, or any suitable combination thereof) can include, for example, a processor 812 and a processor 814 that may execute the instructions 816. The term “processor” is intended to include a multi-core processor that may comprise two or more independent processors (sometimes referred to as “cores”) that can execute instructions contemporaneously. Although FIG. 8 shows multiple processors 810, the machine 800 may include a single processor with a single core, a single processor with multiple cores (e.g., a multi-core processor), multiple processors with a single core, multiple processors with multiples cores, or any combination thereof.

The memory/storage 830 can include a memory 832, such as a main memory, or other memory storage; and a storage unit 836, both accessible to the processors 810 such as via the bus 802. The storage unit 836 and memory 832 store the instructions 816 embodying any one or more of the methodologies or functions described herein. The instructions 816 can also reside, completely or partially, within the memory 832, within the storage unit 836, within at least one of the processors 810 (e.g., within the processor's cache memory), or any suitable combination thereof, during execution thereof by the machine 800. Accordingly, the memory 832, the storage unit 836, and the memory of the processors 810 are examples of machine-readable media.

As used herein, the term “machine-readable medium” means a device able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)), or any suitable combination thereof. The term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine (e.g., processors 810), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 850 can include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 can include many other components that are not shown in FIG. 8. The I/O components 850 are grouped according to functionality merely for simplifying the following discussion, and the grouping is in no way limiting. In various example embodiments, the I/O components 850 can include output components 852 and input components 854. The output components 852 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures; or other tactile input components), audio input components (e.g., a microphone), and the like.

In further example embodiments, the I/O components 850 can include biometric components 856, motion components 858, environmental components 860, or position components 862 among a wide array of other components. For example, the biometric components 856 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 can include acceleration sensor components (e.g., an accelerometer), gravitation sensor components, rotation sensor components (e.g., a gyroscope), and so forth. The environmental components 860 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 862 can include location sensor components (e.g., a GPS receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 850 may include communication components 864 operable to couple the machine 800 to a network 880 or devices 870 via a coupling 882 and a coupling 872, respectively. For example, the communication components 864 include a network interface component or other suitable device to interface with the network 880. In further examples, the communication components 864 include wired communication components, wireless communication components, cellular communication components, Near Field Communication (NFC) components, Bluetooth® components (e.g., Bluetooth® Low Energy), WI-FI® components, and other communication components to provide communication via other modalities. The devices 870 may be another machine or any of a wide variety of peripheral devices (e.g., a peripheral device coupled via a USB).

Moreover, the communication components 864 can detect identifiers or include components operable to detect identifiers. For example, the communication components 864 can include RFID tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof′. In addition, a variety of information can be derived via the communication components 864, such as location via Internet Protocol (IP) geolocation, location via WI-FI® signal triangulation, location via detecting a BLUETOOTH® or NFC beacon signal that may indicate a particular location, and so forth.

In various example embodiments, one or more portions of the network 880 can be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a WI-FI® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide interoperability for Microwave Access (WiMAX), Long Term Evolution (LTE) standard, others defined by various standard-setting organizations, other long range protocols, or other data transfer technology.

The instructions 816 can be transmitted or received over the network 880 using a transmission medium via a network interface device (e.g., a network interface component included in the communication components 864) and utilizing any one of a number of well-known transfer protocols (e.g., Hypertext Transfer Protocol (HTTP)). Similarly, the instructions 816 can be transmitted or received using a transmission medium via the coupling 872 (e.g., a peer-to-peer coupling) to the devices 870. The term “transmission medium” shall be taken to include any intangible medium that is capable of storing, encoding, or carrying the instructions 816 for execution by the machine 800, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
authenticating a user by decrypting an encrypted message with a private key of a key pair to expose a one-time password in the encrypted message, the one-time password generated from a user ID in response to authenticating the user on a client device using biometric data, the biometric data received through a biometric sensor of the client device, the encrypted message generated by encrypting the one-time password with a public key of the key pair in response to the user being authenticated using the biometric data, the encrypted message sent from the client device to a sensor interface of an access point, the encrypted message further transmitted from the access point over a network to a network address of an authentication server;
identifying the user ID using the one-time password; and
initiating one or more network session environments pre-configured for the user using the user ID.

2. The method of claim 1, wherein the one or more network session environments are initiated using one or more application programming interfaces of the one or more network session environments.

3. The method of claim 1, wherein the one or more network session environments are environments for one or more of the following: a physical access control system, a network phone system, a computing environment instantiated on a physical computer, an air conditioning system, and a lighting system.

4. The method of claim 1, further comprising:
terminating the one or more network session environments at a pre-specified time.

5. The method of claim 1, further comprising:
transmitting a liveness challenge to the user, the liveness challenge configured to detect whether the user is using the one or more network session environments by asking the user to generate input data; and
terminating the one or more network session environments based on not receiving the input data in response to the liveness challenge.

6. The method of claim 1, wherein the biometric data is received through a biometric sensor of the client device.

7. The method of claim 6, wherein the encrypted message does not include the biometric data.

8. The method of claim 1, wherein the access point comprises an electronic lock for a building entrance, a wireless network sensor, and a control box, the wireless network sensor configured to wirelessly receive the encrypted message, the control box configured to drive current to the electronic lock of the building entrance.

9. The method of claim 8, wherein the building entrance comprises one or more of the following: a door of a building, a gate of the building, or a window of the building.

10. The method of claim 8, wherein the control box is natively configured to transmit a validation message to a native network address different from the network address of the authentication server.

11. The method of claim 10, further comprising:
updating the native network address of the control box with the network address of the authentication server.

12. The method of claim 1, wherein the public key is stored on non-transitory memory on the client device and the private key is stored on non-transitory memory accessible to the authentication server.

13. The method of claim 1, wherein the one-time password is generated using a one-time password scheme, wherein the one-time password scheme uses the user ID as a seed.

14. A system comprising:
one or more processors of a machine; and
a memory comprising instructions that, when executed by the one or more processors, cause the machine to perform operations comprising:
authenticating a user using biometric data received from the user through a client device;
in response to authenticating, generating a one-time password from a user identifier (ID) assigned to the user;
generating an encrypted message by encrypting the one-time password with a public key of a key pair assigned to the user, the key pair including the public key and a corresponding private key;
transmitting the encrypted message to a sensor interface of an access point;
transmitting the encrypted message over a network to a network address of an authentication server;
authenticating the user by decrypting the encrypted message with the private key of the key pair to expose the one-time password;
identifying the user ID using the one-time password; and
initiating one or more network session environments pre-configured for the user using the user ID.

15. The system of claim 14, wherein the one or more network session environments are initiated using one or more application programming interfaces of the one or more network session environments.

16. The system of claim 14, wherein a control box transmits the encrypted message over the network, and wherein the control box is natively configured to transmit a validation message to a native network address different from the network address of the authentication server.

17. The system of claim 16, the operations further comprising:
updating the native network address of the control box with the network address of the authentication server.

18. The system of claim 14, wherein the public key is stored on non-transitory memory on the client device and the private key is stored on non-transitory memory accessible to the authentication server.

19. A non-transitory machine-readable storage medium embodying instructions that, when executed by a machine, cause the machine to perform operations comprising:
authenticating a user using biometric data received from the user through a client device;
in response to authenticating, generating a one-time password from a user identifier (ID) assigned to the user;
generating an encrypted message by encrypting the one-time password with a public key of a key pair assigned to the user, the key pair including the public key and a corresponding private key;
transmitting the encrypted message to a sensor interface of an access point;
transmitting the encrypted message over a network to a network address of an authentication server;
authenticating the user by decrypting the encrypted message with the private key of the key pair to expose the one-time password;
identifying the user ID using the one-time password; and
initiating one or more network session environments pre-configured for the user using the user ID.

20. The non-transitory machine-readable storage medium of claim 19, wherein the control box is natively configured to transmit a validation message to a native network address different from the network address of the authentication server, and wherein the operations further comprise:
updating the native network address of the control box with the network address of the authentication server.
